(19) United States
(12) Patent Application Publication
(10) Pub. No.: US 2017/0083671 A1
(43) Pub. Date: Mar. 23, 2017

(54) APPARATUS FOR MAINTENANCE SUPPORT IN MEDICAL TECHNOLOGY DEVICES

(71) Applicants: Thomas Benner, Erlangen (DE); Andreas Potthast, Erlangen (DE)

(72) Inventors: Thomas Benner, Erlangen (DE); Andreas Potthast, Erlangen (DE)

(21) Appl. No.: 15/267,584

(22) Filed: Sep. 16, 2016

(30) Foreign Application Priority Data
Sep. 17, 2015 (DE) 102015217838.2

(51) Int. Cl. G06F 19/00; G06K 7/10; G06K 7/14; G06Q 10/00

(52) U.S. Cl. CPC G06F 19/327; G06Q 10/20; G06K 7/10722; G06K 7/1413; G06K 7/1417

(57) ABSTRACT

An apparatus for maintenance support of a medical technology device. The apparatus comprises a detection facility, a controller, an access facility and an output facility. The detection facility is configured for detecting a relative position of the apparatus in respect of the medical technology device. The access facility is configured to store maintenance information on a storage device. The output facility is configured for outputting information. The controller is configured to output maintenance information as a function of the relative position of the output facility in respect of the medical technology device by way of the output facility.

### CROSS-REFERENCE TO RELATED APPLICATIONS

This application claims the benefit of DE 10 2015 217 838.2 filed Sep. 17, 2015, which is hereby incorporated by reference in its entirety.

### TECHINCAL FIELD

Embodiments relate to an apparatus for maintenance support of a medical technology device.

### BACKGROUND

Medical technology devices may be complex and high maintenance devices. The medical technology devices may be used in small numbers of units and on account of rapid technical development in a plurality of variants.

The devices produce a significant potential for risk in the case of incorrect maintenance. X-ray devices operate with high voltages and may emit invisible ionizing radiation that may be hazardous to maintenance staff. Conversely, an incorrectly maintained x-ray device may also prove hazardous to patients or operating staff.

Although magnetic resonance tomography systems do not use ionizing radiation, there may be a risk to maintenance staff and the magnetic resonance tomography system on account of extremely strong magnetic fields, for example during the use of unsuitable tools made of magnetic materials. The gradient control also operates with high current ratings and voltages. High frequency outputs in the kilowatt range are used to excite the hydrogen nuclei.

There is therefore the need for an apparatus that makes the maintenance of medical technology devices simpler and safer.

### SUMMARY AND DESCRIPTION

The scope of the present invention is defined solely by the appended claims and is not affected to any degree by the statements within this summary The present embodiments may obviate one or more of the drawbacks or limitations in the related art.

An embodiment provides an apparatus for the computer-aided widening of the perception of the maintenance of a medical technology device.

The apparatus includes a detection facility for detecting a relative position of the apparatus in respect of the medical technology device. The detection facility may be a camera in connection with a pattern recognition unit. The pattern recognition unit, for example, may optically detect features of the medical technology device and determine a relative position of the apparatus in respect of the medical technology device therefrom. The detection facility may use sound or ultrasound signals, radio waves or other positioning systems such as e.g. laser scanners or magnetic field sensors. For detection facilities, a relative position may be detected precisely, e.g. at one meter, half a meter, 10 centimeters, one centimeter or more precisely. Furthermore, the detection facility is also able to detect the relative position within a building. The relative position includes the position as a point in the room, but also an alignment in respect of the medical technology device, both for the apparatus and also for the medical technology device itself, so that the detection facility may detect for example, that the apparatus is one meter away from the front side of the medical technology device and is aligned toward the medical technology device.

The apparatus further includes a controller and an access facility on a storage device with maintenance information. The controller is connected by signals to the detection facility and obtains information here from relating to the relative position. The controller may access maintenance information from a storage device by way of the access facility, and is configured to output information to a user by way of an output facility.

The apparatus may be implemented in an individual device such as a laptop or tablet PC, that has a camera as the detection facility, and which, together with the processor, may analyze a recorded image and determine a position and location relative to the medical technology device. Similarly, the storage device may be provided with the maintenance information as a hard disk in the tablet PC. The output is then done by way of the screen of the tablet PC or acoustically by way of a receiver.

In one embodiment the apparatus includes a camera and a display that, for example, are worn on the head of a maintenance engineer. The camera is connected to a central controller of the apparatus in a server by way of a wireless connection such as WLAN, Bluetooth or mobile radio network. The server determines a relative position from an image of the camera and/or sensors (ultrasound, RF, magnetic field, light, acceleration) and sends maintenance information to be output on the display.

According to an embodiment, other forms of distributing the functions may be used, for example, the camera may be connected by way of a wireless connection to a controller in a notebook computer or modality PC, that has access to a storage device with maintenance information internally or by way of a data network.

The detection facility of the apparatus may be arranged on the medical technology device or surroundings of the medical technology device. The detection facility may detect the relative position of the display and the maintenance engineer.

The controller is configured to output maintenance information as a function of the relative position of the output facility in respect of the medical technology device by way of the output facility.

Since the maintenance information is output to the engineer as a function of the relative position, the controller may output the location of components of the medical technology device in the display or may direct the maintenance engineer to a component using corresponding messages. The maintenance engineer may be warned if the maintenance engineer is in an area of risk, e.g. in a radiation area of an x-ray tube or an active area of a superconducting field magnet.

In one embodiment, the detection facility has a camera and the detection facility is configured to detect an optical feature on the medical technology device. A camera is an optical system, that in the visible, ultraviolet or infrared range, permits an at least two-dimensional mapping of an object. By correlating with the maintenance information, the detection facility is able to determine the relative position of the output facility relative to the medical technology device. The output facility may be arranged in a fixed relative position in respect of the camera, e.g. in a shared housing or frame, or the camera may simultaneously detect an image of the medical technology device and the output facility. In order to detect the relative position of the camera in respect of the medical technology device, the detection facility may compare the camera image with stored patterns in the maintenance information and suggest a relative position in the event of a corresponding concordance.

A cost effective camera advantageously permits a detection of the relative position of the detection facility and of the output facility without having to make special provisions on the medical technology device.

In an embodiment, the detection facility is configured to detect a machine-readable coding as an optical feature.

Machine-readable codings such as barcodes or QR codes may be detected using a camera. Since the codings are applied to predetermined elements and thereupon in predetermined positions, a unique position of the camera may be determined by the detection unit by detecting a number of codings using the camera.

In one embodiment, the detection facility is configured to identify elements installed in the medical technology device using coding.

Machine-readable codings may carry further information, such as a name of the element to which the codings are applied. A simple and reliable distinction between the individual elements may be made by the detection facility, so that maintenance information assigned to the elements may be output by way of the output facility.

In one embodiment, the optical feature is an outer shape of an element of the medical technology device. The detection facility includes a pattern recognition unit that is configured to identify elements of the medical technology device using pattern recognition.

Pattern recognition provides for elements to be identified without making provisions on the medical technology device. Pattern recognition works with older devices that may subsequently be maintained without the devices having to be retrofitted with corresponding markers.

In one embodiment, the controller is configured to output maintenance information as a function of the identified elements.

The equipment of a medical technology device may be identified and only maintenance information relevant therefor is indicated in a maintenance procedure. A corresponding terminal lay-out may also be outputted.

In one embodiment, the pattern recognition unit is configured to identify a number of different elements of the medical technology device and the relative position of the different elements with respect of one another.

By combining the position of a number of elements, a more precise and reliable identification of the relative position of the detection facility is identified in respect of the medical technology device.

In one embodiment, the controller is configured to compare the relative position of the different elements with predetermined relative positions in the maintenance information and to output a message by way of the output facility in the case of a difference.

The controller may identify, for example, whether modules or cables are inserted at the correct insertion point or with the correct orientation and may output corresponding messages to the maintenance engineer.

In one embodiment, the output facility is a monitor. The monitor may be a display of a laptop or tablet PC for example. The output facility may also be glasses for virtual reality, in which either an image of the surroundings recorded by the camera is displayed together with the maintenance information or transparent glasses, in which maintenance information is also shown by way of a projector, a semi-transparent layer or a semi-reflective mirror. The controller is configured to show warning messages, from the maintenance information, relevant to identified elements of the medical technology device at one position on the output facility as a function of the image detected by the camera. With a non-transparent display, such as e.g. a tablet PC, the maintenance information is shown via the display of the image detected by the camera in the immediate vicinity or via the display of an identified or recognized element of the medical technology device. With a semi-transparent display, the controller selects the position on the display such that the information shown in the vicinity of or above the position of the element of the medical technology device observed by the display is visible to the maintenance engineer. The controller correlates the relative position of the camera, the display and the medical technology device. The camera is arranged in a predetermined relative position in respect of the display, for example, on the frame of VR glasses so that the position of an element in the image of the camera corresponds directly to a position in the display.

The maintenance engineer may rapidly and immediately assign a piece of information to a specific element.

In one embodiment, the maintenance information is a sequence of operations of a maintenance process. The controller is configured to characterize the elements in the image output on the output apparatus as a function of the sequence of operations of the maintenance process.

The apparatus detects the sequence of operations by way of the camera or the apparatus has an input facility, e.g. an input button, a gesture recognition or speech recognition, with which the maintenance engineer signals the progress in the sequence of operations.

The amount of information shown may be reduced simultaneously and the maintenance engineer may be directed by the individual steps of the maintenance sequence of operations.

In one embodiment, the apparatus includes a communication facility for exchanging information with the medical technology device. The communication facility may be a wireless radio link via WLAN, Bluetooth or other wireless transmission techniques for instance, but also a connecting line between the apparatus and the medical technology device.

The apparatus may control the medical technology device and spare the maintenance engineer from performing corresponding inputs.

In one embodiment, the controller is configured to query status information of the medical technology device via the communication facility and output the same via the output apparatus as a function of the relative position.

The maintenance engineer may identify the status of elements of the medical technology device rapidly and without corresponding manual inputs.

In one embodiment, the controller is configured to evaluate the status information as a function of the relative position and to output a warning message by way of the output facility as a function of the result.

The controller may identify, on the basis of the relative position, that the maintenance engineer is in an area of risk or is in close proximity thereto, and to query, as a function thereof for example, whether an x-ray emitter is active and to mark the area of risk in red in the display and to output a warning message. Accidents during maintenance may be avoided.

In one embodiment, the apparatus includes an input apparatus and the controller is configured to change the maintenance information as a function of an input by way of the input apparatus.

The maintenance engineer may adjust the maintenance procedure of the process or to correct possible errors.

### BRIEF DESCRIPTION OF THE FIGURES

FIG. 1 depicts a schematic representation of an apparatus with a medical technology device according to an embodiment.

FIG. 2 depicts a schematic representation of an apparatus with a medical technology device according to an embodiment.

### DETAILED DESCRIPTION

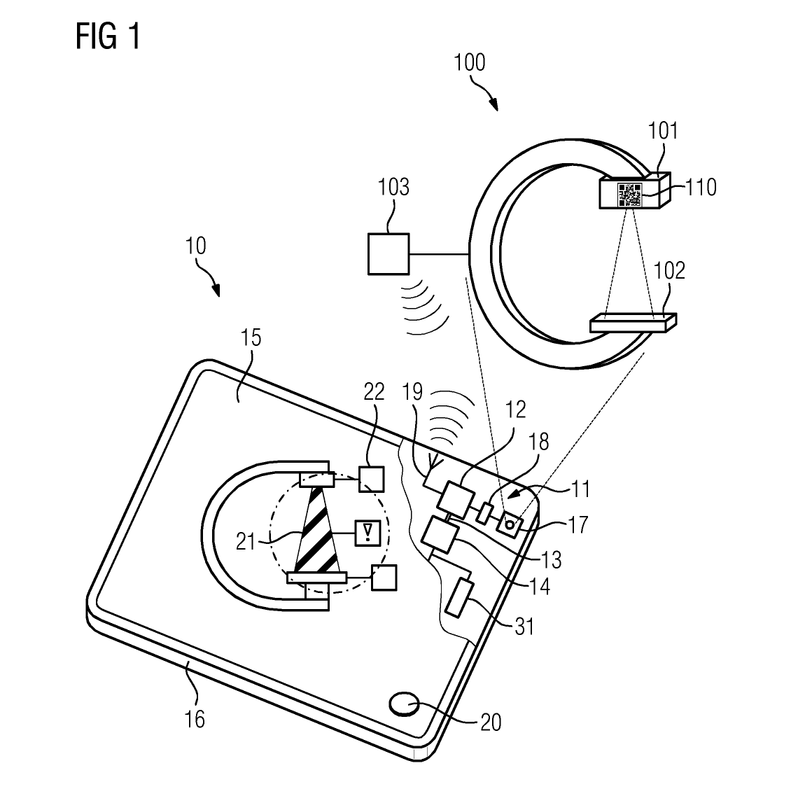

FIG. 1 shows a schematic representation of an embodiment of the apparatus 10. In FIG. 1, the apparatus 10 is a tablet computer. The tablet computer has a housing 16, in which a controller 12 in the form of a processor is provided.

The controller 12 is connected by signals to the detection facility 11 by way of a signal line. The detection facility 11 has a camera 17, that is configured to detect an image of the environment. FIG. 1 depicts an image of a medical technology device, here a C-arm x-ray device 100. The image of the camera is further processed by a pattern recognition unit 18.

The pattern recognition unit 18 is configured to analyze the image detected by the camera 17. For example, the pattern recognition unit 18 may be configured to identify patterns and edges and to identify objects in the image. The pattern recognition unit 18 to be configured to identify and decode a machine-readable coding such as a QR code 110 on the x-ray emitter 101.

The data determined is compared with stored data from the storage device 14. The stored data is forwarded by way of the controller 12 out of the storage device 14 to the pattern recognition unit 18. The pattern recognition unit 18 may have direct access to the storage device 14. Information relating to the medical technology device 100, for example, the type and arrangement of the individual elements is provided from the storage device 14. The pattern recognition unit 18 may determine the relative position of the camera 17 and thus the output unit 15 in respect of the medical technology device 100 from the location, the size and perspective distortion of the individual elements in the image and forward the relative position to the controller.

The pattern recognition unit 18 may be configured with alternative hardware, e.g. a signal processor or as an FPGA. The pattern recognition unit 18 may be configured as a software module by the controller 12 or for a functional division to take place between the controller 12 and a dedicated hardware.

A machine readable coding in the form of QR codes may facilitate the distinction and unique identification of individual elements. Different hardware revisions or firmware statuses may be distinguished using the machine readable coding.

In one embodiment, the controller 12 may compare the identified location of an element in the medical technology device 100 with stored maintenance information that specifies a target position. If the targeted position does not correspond with a detected position, a corresponding warning message may be outputted by the controller 12. Modules or cables that have been incorrectly inserted may be identified.

In one embodiment, the apparatus includes a communication facility 19. The communication facility 19 may be, for example, a WLAN, Bluetooth interface, or a USB cable connection. The controller 12 may use the communication facility to communicate with a controller 103 of the medical technology device 100. The controller 12 may query the status of individual elements of the medical technology device 100, for example, firmware statuses.

The controller 12 may query operating statuses of the medical technology device 100 and output warning messages as a function thereof. In FIG. 1, with a C-arm shown, the operating statuses or warning messages may be the information, for example, related to whether the x-ray emitter 101 is active and outputs x-ray beams. The controller may output a warning message 21 on the output facility 15, e.g. a touch-screen. The warning message may combine an image of the medical technology device 100 detected by the camera 17 with the warning message at the relevant point in the mapping. For example, a virtual beam cone is shown here as a warning message 21 in FIG. 1. The virtual beam cone specifies the area in which the maintenance engineer is at risk.

Other maintenance relevant messages 22 may also be shown in the image that specify operating parameters of the respective element, or whether the respective element needs replacing. The maintenance relevant messages 22 may be shown in the image by way of or in the immediate vicinity of the relevant element.

For example, if an incorrectly inserted cable was identified, then the incorrect position is marked by the controller in red in the image and simultaneously, the correct image in green. Similarly, during the installation of hardware, a correct target position may be indicated in the medical technology device 100.

FIG. 1 includes a control element 20. As depicted in FIG. 1, the control element 20 may be a virtual button on the touch screen. The control element 20 permits the maintenance engineer to make inputs on the controller 12 and outputs the progress of the maintenance activity so that the controller 12 may show further maintenance information relating to a next step on the output facility 15. The maintenance engineer may be able to make specific inputs relating to maintenance using the control element 20. The maintenance engineer may be able to adjust, change or correct the stored maintenance information. Speech or gesture recognition may be used as a control element in addition to real or virtual buttons.

Energy is supplied by way of a battery 31.

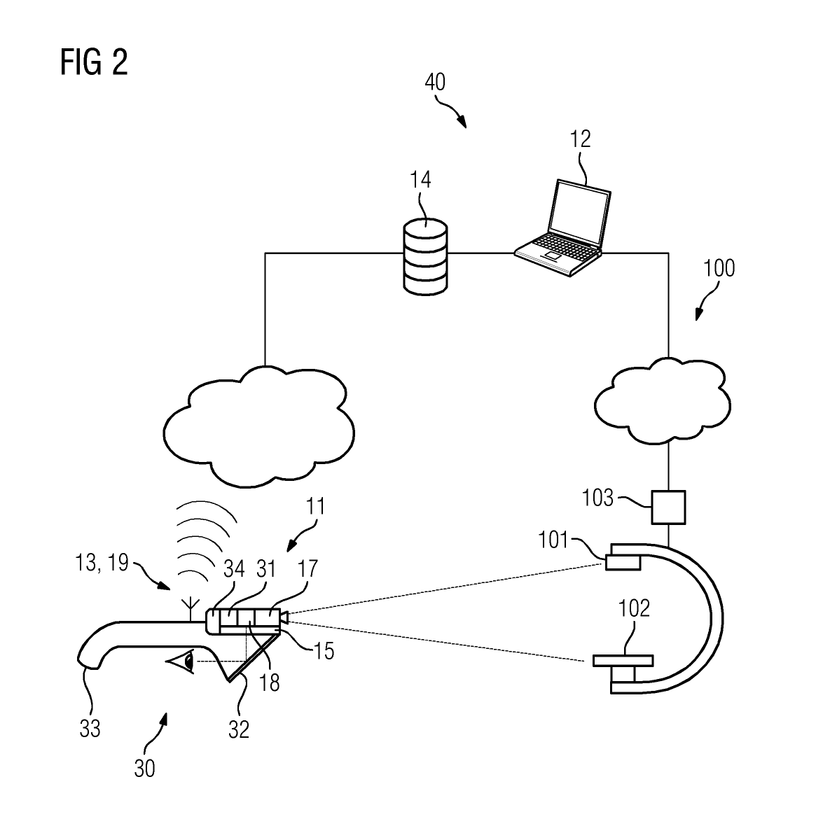

FIG. 2 depicts an embodiment of the apparatus. The same objects are designated with the same reference characters.

FIG. 2 differs from the FIG. 1 in that all elements of the apparatus are no longer joined in a housing, but are instead partially spatially separated from one another and communicate wirelessly or in a wired manner with one another.

The apparatus 10 includes a portable unit 30 and a stationary unit 40.

The portable unit 30 includes a detection unit 11. The detection unit includes a camera 17 and a pattern recognition unit 18. In order to exchange data with the stationary unit 40, the portable unit 30 includes a communication facility 19. The communication facility 19 may communicate wirelessly, e.g. by using WLAN, Bluetooth or other mobile data networks. The exchange of data takes place in both directions, the data detected by the camera 17 is transmitted away from the portable unit 30, and conversely maintenance information is received from the portable unit 30 for output purposes.

The pattern recognition unit 18 may reduce the amount of data in the camera 17, so that the capacity of mobile networks is sufficient for transmission to the controller 12. A display, the image of which is shown in the field of view of a maintenance engineer by way of a partially reflective mirror 32, serves as an output unit 15.

The elements of the portable unit 30 are arranged on a glasses frame 33 for example, so that the maintenance engineer may carry the portable unit 30 on his head, hands free. Energy may be supplied by a battery 31.

The stationary unit 40 includes a controller 12 and a storage device 14. The controller 12 may be a PC or server. The maintenance information may be retained in the storage device 14 just once for a plurality of portable units 30, that reduces the storage requirement and simplifies the update. Substantially larger quantities of data may also be retained compared to on a storage device of a tablet computer, including, for example, data involving moving images. The central controller 12 may provide a substantially more effective image or pattern recognition. The central controller 12 may be able to rapidly identify elements of the medical technology device 100 and its relative position from the data transmitted by the pattern recognition unit 18.

The controller 12 provides the maintenance information and warning messages to be outputted on the output facility 15 at a position that corresponds to the position of the element in the optical perception of the wearer of the portable unit. The information overlies the element in the field of view, for example, or is shown directly adjacent.

The portable facility includes a gyro sensor or acceleration sensor 31 as an input element, with which head movements may be recorded as inputs. A gyro sensor also assists the pattern recognition unit 18 and/or the controller 12 with determining the location as part of the relative position of the portable unit 30.

Push buttons, touch sensitive surfaces on the frame 33 or a microphone in connection with a speech recognition may also be used as input elements

The camera 18 may be arranged on the medical technology device 100 or in the room for example, so that the camera 18 may record both the maintenance engineer and also the medical technology device 100.

A plurality of cameras 18 may be used to assist in a spatial detection.

Additional sensors (e.g. ultrasound, magnetic field sensor) that permit the position and orientation of the camera in the room to be determined more easily may be used

Instead of a camera 18, other techniques, such as e.g. a 3D laser scanner may also be used in the detection facility 11. In conjunction with machine-readable codings, a reliable detection of the relative position and the identification of the elements of the medical technology device 100 may be used. Alternative techniques may be used.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. An apparatus for computer aided perception of the maintenance of a medical technology device, the apparatus comprising:
a detection facility configured to detect a relative position of the apparatus in respect of the medical technology device;
an access facility on a storage device configured to store maintenance information;
an output facility configured to output information; and
a controller configured to output the maintenance information as a function of the relative position of the output facility in respect of the medical technology device by way of the output facility.

2. The apparatus of claim 1, wherein the detection facility comprises:
a camera, wherein the detection facility is configured to detect an optical feature on the medical technology device and to determine, by correlation with the maintenance information, the relative position of the output facility relative to the medical technology device.

3. The apparatus of claim 2, wherein the optical feature is a marker with a machine-readable coding.

4. The apparatus of claim 3, wherein the detection facility is configured to identify elements installed in the medical technology device by the machine readable coding.

5. The apparatus of claim 2, wherein the detection facility further comprises:
a pattern recognition unit; wherein the optical feature is an outer shape of an element of the medical technology device and wherein the pattern recognition unit is configured to identify elements of the medical technology device using pattern recognition.

6. The apparatus of claim 4, wherein the controller is configured to output maintenance information as a function of the identified elements.

7. The apparatus of claim 5, wherein the pattern recognition unit is configured to identify a number of different elements of the medical technology device and a relative position of the number of different elements in respect of one another.

8. The apparatus of claim 7, wherein the controller is configured to compare the relative position of the different elements with predetermined relative positions in the maintenance information and to output a message by way of the output facility in the case of a difference.

9. The apparatus of claim 4, wherein the output facility is a monitor; wherein the controller is configured to output warning messages relevant to identified elements of the medical technology device, from the maintenance information, at a position on the output facility as a function of the image detected by the camera.

10. The apparatus of claim 9, wherein the maintenance information is a sequence of operations of a maintenance process and the controller is configured to characterize the elements as a function of the sequence of operations of the maintenance process in the image output on the output facility.

11. The apparatus of claim 2, further comprising:
a communication facility configured for exchanging information with the medical technology device.

12. The apparatus of claim 11, wherein the controller is configured to query status information of the medical device via the communication facility and to output the status information via the output apparatus as a function of the relative position.

13. The apparatus of claim 12, wherein the controller is configured to evaluate the status information as a function of the relative position and to output a warning message via the output facility as a function of the result.

14. The apparatus of claim 2, further comprising:
an input apparatus; wherein the controller is configured to change the maintenance information as a function of an input of the input apparatus.

15. The apparatus of claim 5, wherein the controller is configured to output maintenance information as a function of the identified elements.

16. The apparatus of claim 5, wherein the output facility is a monitor; wherein the controller is configured to output warning messages relevant to identified elements of the medical technology device, from the maintenance information, at a position on the output facility as a function of the image detected by the camera.
